(19) United States
(12) Patent Application Publication
(10) Pub. No.: US 2025/0192706 A1
(43) Pub. Date: Jun. 12, 2025

(54) METHOD FOR ACTUATING A PERMANENT MAGNET SYNCHRONOUS MOTOR

(71) Applicant: Continental Automotive Technologies GmbH, Hannover (DE)

(72) Inventors: Dominik Schulte, Mühltal (DE); Bogdan Budianu, Oberursel (DE); Peter Stauder, Mainz (DE); Tom Kaufmann, Ippenschied (DE); Lucas Walter, Frankfurt am Main (DE)

(73) Assignee: Continental Automotive Technologies GmbH, Hannover (DE)

(21) Appl. No.: 18/973,210

(22) Filed: Dec. 9, 2024

(30) Foreign Application Priority Data
Dec. 8, 2023 (DE) 10 2023 212 393.2

(51) Int. Cl. H02P 21/22

(52) U.S. Cl. CPC H02P 21/22

(57) ABSTRACT

A method for actuating a permanent magnet synchronous motor is disclosed. The method provides simplifications in the calculations required for the control in order to reduce the computing time while at the same time achieving the lowest possible deviation from the optimum d-q current point or current vector. A permanent magnet synchronous motor suitable for carrying out the method is also disclosed.

### TECHNICAL FIELD

A method for actuating a permanent magnet synchronous motor is disclosed. An electronic control device suitable for carrying out the method and a brake system comprising a permanent magnet synchronous motor are also disclosed.

### BACKGROUND

Permanent magnet synchronous motors (PMSM) or permanent magnet synchronous machines are used in a wide variety of areas and products as they have very good capabilities for converting electrical variables such as voltage and current to mechanical variables such as rotational speed and torque and also allow for small designs and are low-maintenance.

Synchronous motors of this kind are also used in a variety of ways and in a wide variety of designs and embodiments in modern motor vehicles. For example, electric-motor-driven pumps, for example hydraulic pumps, are known to generate pressure in a brake system.

The permanent magnet synchronous motors may comprise an electronic control device comprising a controller, an interface and an inverter or converter for the purpose of actuation. For applications in the automotive sector, the drive energy can be provided by the vehicle's internal battery or the motor vehicle's electrical system.

For the stable operation of such a vehicle electrical system, it is typically necessary to achieve a balance between power generation and power consumption. This may require that the total power consumed in the case of current consumers, such as a permanent magnet synchronous motor of the brake system, be limited in order not to overload the vehicle electrical system.

This power limit can be calculated, for example by multiplying an operating voltage of the vehicle electrical system by a maximum permissible current. For example, the maximum permissible current may also change, depending on the operating state of the vehicle electrical system. This may make it necessary to adapt the operation of a permanent magnet synchronous motor so that it does not consume more than the maximum permissible power.

Control algorithms, which are typically integrated in a controller or in an electronic control device, are required to operate the permanent magnet synchronous motor accordingly. The control algorithms may be a precise actuation of the converter, which in accordance with known arrangements in the automotive sector may have, for example, a B6 bridge circuit comprising power semiconductor components.

The power semiconductor components can be actuated using a pulse-width-modulated actuation signal (PWM), wherein an alternating voltage and current profile for the operation of the synchronous motor can be generated in the converter from the direct current, for example from the vehicle battery. In this way, controlled voltages or currents can be fed to the synchronous motor and generate a rotating or stator field at the stator, which can bring about a torque in the rotor.

Depending on which part is considered to be part of the motor control, there is either a rotational speed requirement as the main input of the control or a torque requirement directly. In the first case, a rotational speed controller can be used to convert the rotational speed requirement to a torque requirement.

Regardless of how the torque requirement is generated, these torque requirements must be converted to corresponding currents or current requirements for optimum actuation of the synchronous motor. For further consideration of the variables that are relevant to the actuation, the three phases of the synchronous motor (U, V, W) can be transferred to a two-axis coordinate system that is fixed with respect to the rotor and has the axes d and q. A torque requirement can thus be converted to a d and a q current requirement, which can then be controlled via appropriate control loops.

Several approaches are known for converting the torque requirement into this d-q current requirement, where two types of approach can be distinguished.

On the one hand, there are the rule-based approaches. The rule-based approaches attempt to control the voltage reserve for controlling the d-q currents.

The rule-based approaches is simple and robust to parameter deviations. However, the additional control loop has a delay and the focus on standard system states is necessary in many cases. The controllers are thus parametrized for certain operating states and lose control quality when leaving these states, because, for example, the properties of magnetic materials differ or they may also change, for example as a result of temperature changes.

The other approach relates to what are known as open-loop or feed-forward strategies. These approaches do not use the voltage reserve for the underlying algorithms, but instead perform a model-based calculation for the d-q current requirements.

With such approaches, however, on one hand the complexity of the calculations required must be taken into account. On the other hand, certain restrictions must also be observed, which may refer, for example, to the direct current source, since exceeding certain power values as outlined above may lead, for example, to damage to the direct current source, such as the battery, or the electrical lines.

### SUMMARY

A method for actuating a permanent magnet synchronous machine should have a complexity which is as low as possible here, so that a simple implementation of the control algorithms, for example in a microcontroller of the control device, is possible.

Furthermore, the method may be used even with synchronous motors of a different design without extensive adjustments.

This object is achieved by a method for actuating a permanent magnet synchronous motor, for example as part of a brake system of a motor vehicle, by an electronic control device and by a brake system comprising a permanent magnet synchronous motor as described rhein.

A first aspect to a method for actuating a permanent magnet synchronous motor comprises the following steps:
ascertaining a first d-q current point P1 in the d-q coordinate system, in which the phase current limit and the voltage limit are observed, and wherein the following additionally applies to the first d-q current point P1:
   the q component of the d-q current point P1 in the d-q coordinate system is zero (i_{q}=0 A), and
   the d component of the d-q current point P1 in the d-q coordinate system is selected to be as small as possible in terms of magnitude,
ascertaining a second d-q current point P2 in the d-q coordinate system, in which the phase current limit and the voltage limit are observed, and wherein a maximum torque can be set,
ascertaining a polynomial N that connects these d-q current points P1, P2 to one another,
ascertaining a d-q current point P3 from the intersection of this polynomial N with the curve of the power limit G_{L},
ascertaining a d-q current point P4 from the intersection of this polynomial N with the curve of the required motor torque G_{M},
selecting an operating point P_{B} from the d-q current points P2, P3, P4 to which the following applies:
   the d-q current point P2, P3, P4 is permissible,
   the d component of this permissible d-q current point P2, P3, P4 has the lowest value in terms of magnitude.

In a further aspect, an electronic control device for actuating a permanent magnet synchronous motor of a motor vehicle, for example as part of a brake system, is designed for carrying out the above-mentioned method.

The permanent magnet synchronous motor may be designed for operating a pump unit, for example a hydraulic pump of a motor vehicle brake system.

The method makes it possible to ascertain a d-q current point or a target voltage vector for actuating the permanent magnet synchronous motor, which represents an optimum under the given restrictions, that is to say the desired or predetermined torque requirement comes as close as possible and additionally also represents the lowest energy consumption.

For the further implementations of actuating a permanent magnet synchronous motor, a d/q transformation for the three-phase system of the synchronous motor is taken as a basis. The d-q coordinate system is generally known in the field of actuating permanent magnet synchronous motors and offers a simple representation of the operating parameters of such a motor. A detailed representation is therefore be omitted at this point. Aspects with regard to the actuation of a permanent magnet synchronous motor are described, for example, in document DE 10 2018 213 939 A1 from the applicant, which is hereby fully incorporated by reference. A transfer of torque requirements of the permanent magnet synchronous motor into a corresponding d-q current requirement can therefore be regarded as a step of the method.

According to one embodiment, the current vector I_{dq} sought for actuation can be determined based on a torque requirement. The torque requirement is in this case typically a specification that determines the torque that the synchronous motor should generate or provide at a specific point in time. From this, a current vector I_{dq} can typically be calculated in the d-q coordinate system, where the above-mentioned restrictions and optimizations are to be taken into account. The torque can be provided, for example, by a vehicle control system or a higher-level vehicle computer or on-board computer of the electronic control device.

The current vector I_{dq} obtained in the d-q coordinate system can therefore represent the current point which comes closest to the desired d-q current requirement and with which the permanent magnet synchronous motor is to be actuated accordingly in order to provide the desired torque as far as possible.

With regard to the permanent magnet synchronous motor, certain restrictions must be observed, which may also be related to the current operating state and which will be discussed below.

The boundary conditions to be observed may include a power limitation of the permanent magnet synchronous motor. The maximum power of the permanent magnet synchronous motor may in this case be set as the product of a specified voltage and a specified maximum current intensity. Failure to comply with the given power limit may result in damage to the motor vehicle electrical system.

The specified voltage may also be referred to as a voltage limit and may correspond in this case to an operating voltage of a vehicle electrical system, for example an electrical system of a motor vehicle. The operating voltage is in this case typically the voltage it is wished to maintain in normal operation. This boundary condition may also be regarded as a “hard” limit, since the voltage applied to the three phases to actuate the synchronous motor, for example, comes from the vehicle electrical system. Therefore, the voltage cannot go beyond this voltage limit.

The following rule may apply to the voltage vector in the d-q coordinate system:

$$0 \leq \sqrt{{U}_{q}^{2} + {U}_{d}^{2}} \leq {U}_{ctrl}$$

where
U_{q}: a q component of the voltage vector in the d-q coordinate system,
U_{d}: a d component of the voltage vector in the d-q coordinate system,
U_{ctrl}: the maximum voltage or the voltage limit.

According to one embodiment, the maximum current intensity or the maximum phase current may represent a further boundary condition to be observed, with this limit also being able to be slightly exceeded briefly, for example when the phase voltage is applied. However, long-term exceedance may lead, for example, to heating of the motor and/or to damage to the electronic components and should therefore be avoided.

The following rule may be adopted for the phase current in the d-q coordinate system:

$$0 \leq \sqrt{{I}_{q}^{2} + {I}_{d}^{2}} \leq {I}_{ph , max}$$

where
I_{q}: a q component of the current vector in the d-q coordinate system,
I_{d}: a d component of the current vector in the d-q coordinate system,
I_{ph, max}: the maximum phase current.

The maximum power can change during operation, for example depending on certain operating states, such as the availability of current generators or the operating state of other current consumers. In addition to the maximum power, a minimum power may also be required, for example in generator operation of the motor. The power limits can therefore be determined in each case at the time of the torque requirement.

The following rule can be assumed for the minimum and maximum power:

$${P}_{DC , min} \leq {P}_{DC} \leq {P}_{DC , max}$$

where
P_{DC}: a possible power,
P_{DC, min}: a minimum power,
P_{DC, max}: a maximum power.

Based on these boundary conditions, the sought current vector I_{dq} can be determined by the method according to the invention in such a way that the above-mentioned boundary conditions are observed and that the corresponding torque comes as close as possible to the desired torque requirement.

A further boundary condition is necessary to determine the optimal target current vector I_{dq}, since the above-mentioned boundary conditions in any case cannot lead to a clear solution.

One embodiment therefore makes provision for the efficiency of the operation of the synchronous motor to be used as further boundary conditions to be observed. In other words, a current vector I_{dq} which observes the current above-mentioned boundary conditions simultaneously comes as close as possible to the desired torque requirement and thereby allows the lowest possible power consumption of the synchronous motor is determined. In other words, a current vector I_{dq} which provides as much torque as possible for the permanent magnet synchronous motor, but also takes up as little power as possible, is sought.

It is assumed here that such a d-q current point or current vector I_{dq} exists in the case of a properly designed motor system. Furthermore, it is assumed that there are not two or more d-q current points that meet the mentioned boundary conditions equally well.

Although the task of determining the optimum d-q current point or current vector I_{dq} according to the given boundary conditions and definitions is theoretically possible, it is so complex that it requires a lot of computing capacity. This makes implementation in a microcontroller, for example, possible.

Against this background, the approach according to the embodiments provides few simplifications in order to reduce the computing time while at the same time achieving the lowest possible deviation from the “perfect” d-q current point or current vector I_{dq}.

The method for actuating a permanent magnet synchronous motor is thus also suitable for a simple implementation in, for example, a microcontroller, since it requires less computing capacity than known methods.

The following text describes the approach, which reduces the complexity of the calculation by way of a model-based approximation method and allows multiple variants depending on the available computing power and the available system parameters.

The method in this case provides a multi-stage approach, wherein first of all two d-q current points P1, P2 in the d-q coordinate system are ascertained independently of one another as starting points, and wherein different conditions for these d-q current points apply or are to be met.

Accordingly, the first d-q current point P1 can first be ascertained, where the phase current limit and the voltage limit are observed, and wherein the following is additionally intended to apply to the first d-q current point P1:
the q component of the current vector P1 in the d-q coordinate system is zero, such that: i_{q_P1}=0 A, and
the d component of the current vector P1 in the d-q coordinate system is selected to be as small as possible in terms of magnitude.

Furthermore, the second d-q current point P2 can be ascertained, where the phase current limit and the voltage limit are likewise observed, and wherein a maximum torque can be set.

A polynomial N that connects these two d-q current points P1, P2 to one another can then be ascertained.

A d-q current point P3 resulting from the intersection of this polynomial N with the curve of the power limit G_{L} of the actuator can then be ascertained.

Finally, a further d-q current point P4 resulting from the intersection of this polynomial N with the curve of the required torque G_{M} can be ascertained.

Accordingly, the method makes provision for a total of four d-q current points P1, P2, P3 and P4 to be determined, where certain restrictions are met for each d-q current point.

The method may furthermore make provision for a current point to then be able to be determined from the three d-q current points P2, P3 and P4 mentioned last as an operating point P_{B}, with the following rules being intended to apply to these:
the d-q current point P2, P3, P4 is permissible,
the d component of this permissible d-q current point (P2, P3, P4) has the lowest value in terms of magnitude.

The current vector I_{dq} associated with this operating point P_{B} can be used to actuate the permanent magnet synchronous motor. The voltage vector which can be used to operate the motor in the desired manner can be determined based on the current vector I_{dq}.

According to an embodiment, the d-q current points, for example P1 and P2, can be ascertained mathematically. The algorithms required for this can be stored in the control device, for example in a microcontroller. This procedure offers being able to optimally determine the respective operating point P_{B} depending on influencing factors that may change over time. For example, it is possible to take into account parameter changes, for example with regard to the motor, or temperature changes, voltage changes in the vehicle electrical system, etc. However, the required computing power must be provided for this purpose, so that the calculation can be carried out promptly.

According to a further embodiment, the d-q current points, for example P1 and P2, or the possible value ranges can be ascertained empirically and/or stored in a table or in a memory and provided for the application of the method.

The type of polynomial N is also included in the computing time. Thus, according to a embodiment, a polynomial of the 1st order can be used, which enables very good approximation to the optimal operating point P_{B} even with low computing effort at the same time.

According to a development, a polynomial N of a higher order, for example a polynomial of the n-th degree with n being 2, 3 or 4, can be used. Even a polynomial of the 2nd order can improve the result quality of the operating point P_{B} still further without increasing the computing effort too much.

A further aspect is a brake system for a motor vehicle having a permanent magnet synchronous motor and a control device as described above, wherein the control device may be designed for carrying out the method as described further above.

The permanent magnet synchronous motor may comprise a stator with phase windings, a rotor with a permanent magnet, and an inverter. A rotor position sensor may also be provided.

The permanent magnet synchronous motor can be actuated in motor operation while observing the boundary conditions with the current vector I_{dq}, but also in generator operation, wherein the regenerative current can be limited so that excessive heating or damage to the battery and/or charging or actuation electronics can be avoided.

### BRIEF DESCRIPTION OF THE DRAWINGS

Further details will become apparent from the description of the illustrated exemplary embodiments and the attached claims.

In the drawings:

FIG. 1 shows a simplified representation of a block diagram for actuating a permanent magnet synchronous motor,

FIG. 2 shows an exemplary embodiment for illustrating the method steps,

FIG. 3 shows a further exemplary embodiment for illustrating the method steps, and

FIG. 4 shows an exemplary embodiment of a flowchart.

### DETAILED DESCRIPTION

In the following detailed description of the embodiments, for the sake of clarity, the same reference signs designate substantially identical parts in or on these embodiments. However, for better clarification of the invention, the embodiments illustrated in the figures are not always drawn to scale.

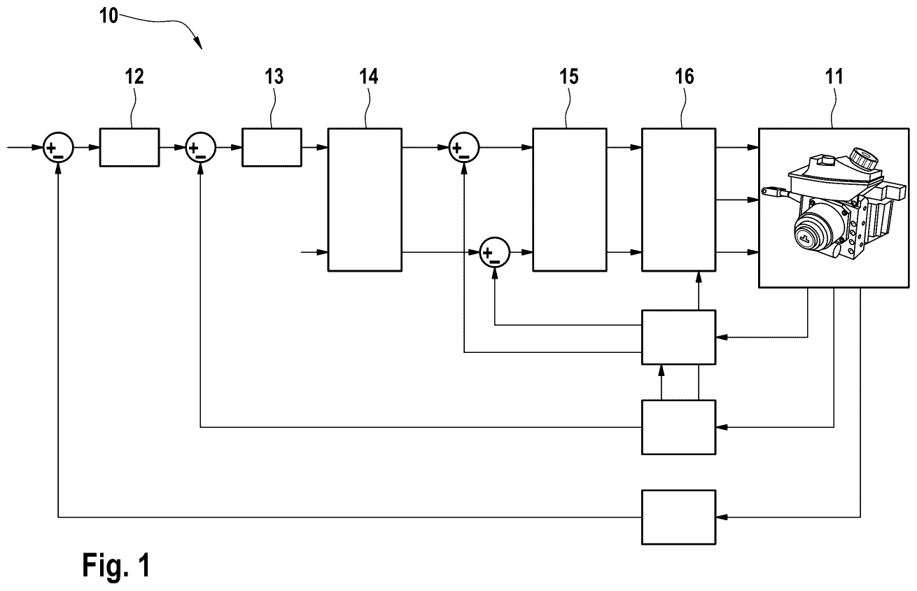

FIG. 1 shows a simplified representation of a block diagram using the example of a controlled system 10 for actuating a permanent magnet synchronous motor 11. The permanent magnet synchronous motor 11 is part of a brake system of a motor vehicle (not illustrated) and is operated together with a pump unit, such as a hydraulic pump, of the motor vehicle brake system.

Variables of the controlled system 10 are the pressure, the speed and the current. In the exemplary embodiment, corresponding controllers or modules are integrated in the controlled system for this purpose, for example a pressure control module 12, a speed control module 13, a module 14 for determining the current vector, a power control module 15 and an actuation module with pulse width modulation 16. Sensors or measuring units may also be provided for detecting the consumed current, position and/or pressure, these not being shown in FIG. 1 for the sake of clarity. In the illustrated example of a controlled system 10, the d-q current point is determined in the module 14 based on a torque requirement from the speed control module 13. Other relevant system variables, such as the rotational speed, the voltage, the temperature or motor parameters, are made available to this module for this purpose. The power control module 15 can then adjust the I_{dq} target current accordingly.

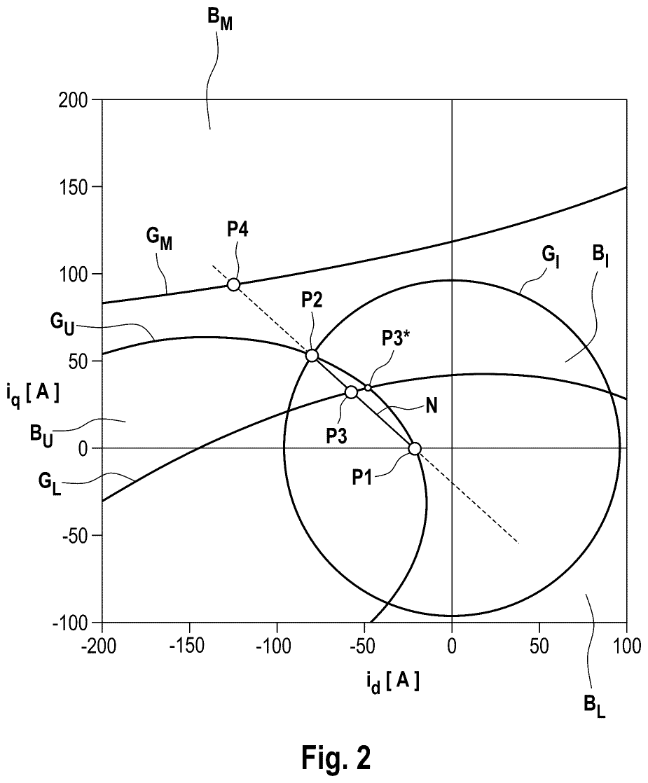

FIG. 2 shows an exemplary embodiment for illustrating the method steps. FIG. 2 shows multiple graphs or families of characteristic curves which represent the validity ranges or the permissible ranges of the voltage, the current intensity, the power and the motor torque as a function of one of the d or q current components.

For example, the reference sign B_{U} denotes the range of the permissible voltage, wherein G_{U} denotes the limit of this family of characteristic curves. The range denoted by B_{U} therefore indicates the sum of the current points that satisfy the voltage limit.

Furthermore, the reference sign B_{I} denotes the range of the permissible current, wherein G_{I} denotes the limit of this family of characteristic curves. The range denoted by B_{I} therefore indicates the sum of the current points that satisfy the phase current limit.

Furthermore, the reference sign B_{L} denotes the range of the permissible power, wherein G_{L} denotes the limit of this family of characteristic curves. The range denoted by B_{L} therefore indicates the sum of the current points that satisfy the power limit.

Finally, the reference sign B_{M} denotes the range of the required torque, wherein G_{M} denotes the limit of this torque range.

The method for actuating the permanent magnet synchronous motor 11 provides the following steps:
1. ascertaining a first d-q current point P1 in the d-q coordinate system, in which the phase current limit and the voltage limit are observed, and wherein the following additionally applies to the first d-q current point P1:
   the q component of the d-q current point P1 in the d-q coordinate system is zero (i_{q_P1}=0 A), and
   the d component of the d-q current point P1 in the d-q coordinate system is selected to be as small as possible in terms of magnitude.

In FIG. 2, the d-q current point P1 is indicated and lies on a horizontal, for which the q component is equal to zero. In addition, the d-q current point P1 is selected in such a way that the d component is as small as possible in terms of magnitude but is still permissible.

In the exemplary embodiment of FIG. 2, the d-q current point P1 is at the limit of the family of characteristic curves G_{U} of the voltage limit, which is thus observed.

The second step of the method is then carried out:
2. ascertaining a second d-q current point P2 in the d-q coordinate system, in which the phase current limit and the voltage limit are observed, and wherein a maximum torque can be set.

In the exemplary embodiment of FIG. 2, the d-q current point P2 is at the limit of the family of characteristic curves G_{U} of the voltage limit and the limit G_{I} of the family of characteristic curves indicating the phase current limit. This means that the d-q current point P2 is also within the permissible value range.

The third step of the method is then carried out:
3. ascertaining a polynomial N that connects these d-q current points P1, P2 to one another.

In the exemplary embodiment of FIG. 2, a polynomial N of the 1st degree is selected, which is placed as a straight line through the two current points P1 and P2.

The fourth step of the method is then carried out:
4. ascertaining a d-q current point P3 from the intersection of this polynomial N with the curve of the power limit G_{L}.

In the exemplary embodiment of FIG. 2, the d-q current point P3 is approximately in the middle section between the two current points P1 and P2. A d-q current point P3 is denoted by the reference sign P3*, which would be obtained if a polynomial of the 1st order were replaced by a polynomial of the 2nd order through the two current points P1 and P2. Minor deviations can be detected, e.g. with regard to the d component of the d-q current point.

The fifth step of the method is then carried out:
5. ascertaining a d-q current point P4 from the intersection of the polynomial N with the curve of the required torque G_{M}.

In the embodiment of FIG. 2, the d-q current point P4 is at the limit G_{M} of the associated family of characteristic curves.

The sixth step of the method is then carried out:
6. selecting an operating point P_{B} from the d-q current points P2, P3, P4 to which the following applies:
   the d-q current point P2, P3, P4 is permissible,
   the d component of this permissible d-q current point P2, P3, P4 has the lowest value in terms of magnitude.

In the exemplary embodiment of FIG. 2, the current point P4 drops out of the group of possible current points P2, P3, P4 because it is outside the voltage limit, the phase current limit and the power limit.

Of the remaining current points P2, P3, the corresponding d component of the current point has the lower value in terms of magnitude. Accordingly, the current point P3 in the exemplary embodiment of FIG. 2 represents the optimal operating point P_{B} for operating the synchronous motor 11.

This current point or the associated current vector I_{dq} meet the given boundary conditions and at the same time represent the most efficient parameter for actuating the synchronous motor 11.

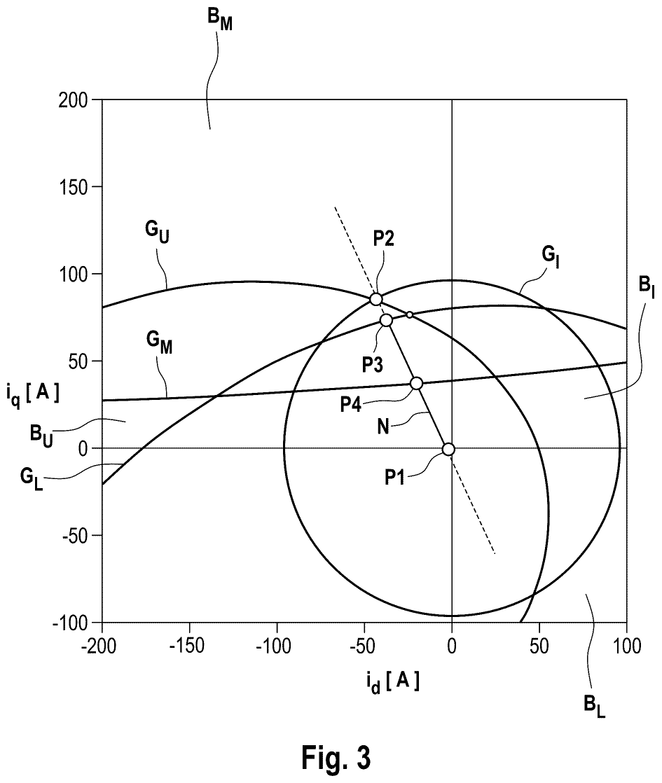

FIG. 3 shows a further exemplary embodiment. In this exemplary embodiment, the determined current points P2 and P3 are outside the required torque range, and so ultimately the current point P4 is the one that is permissible from the group of current points P2, P3 and P4 and is therefore selected for actuation.

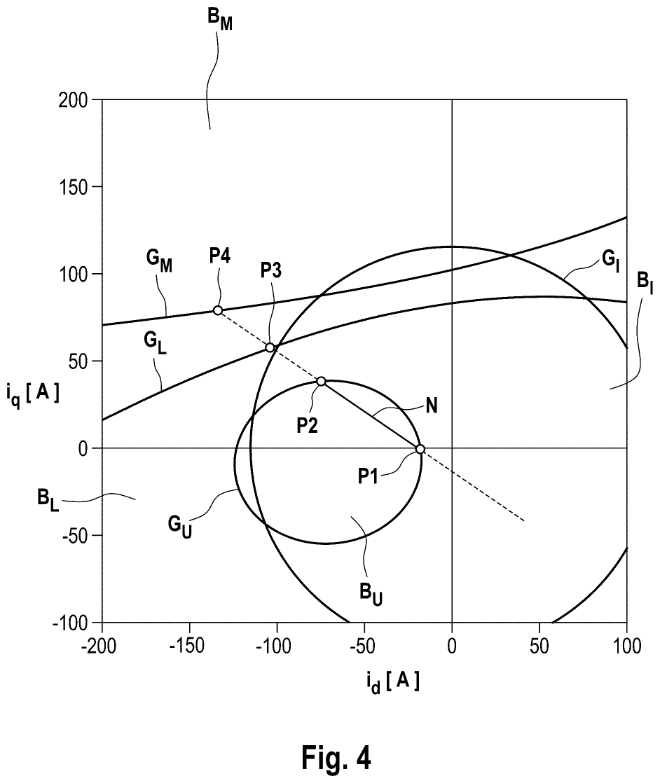

FIG. 4 shows yet a further exemplary embodiment. In this exemplary embodiment, the current point P3 meets the restrictions and is selected as the optimal operating point P_{B}.

1. A method for actuating a permanent magnet synchronous motor, comprising:
ascertaining a first d-q current point in the d-q coordinate system, in which the phase current limit and the voltage limit are observed, and wherein the following additionally applies to the first d-q current point:
the q component of the d-q current point in the d-q coordinate system is zero, and
the d component of the d-q current point in the d-q coordinate system is selected to be as small as possible in terms of magnitude,
ascertaining a second d-q current point in the d-q coordinate system, in which the phase current limit and the voltage limit are observed, and wherein a maximum torque can be set,
ascertaining a polynomial that connects these d-q current points to one another,
ascertaining a d-q current point from the intersection of this polynomial with the curve of the power limit G_{L},
ascertaining a d-q current point from the intersection of this polynomial with the curve of the required torque G_{M}, and
selecting an operating point from the d-q current points to which the following applies:
the d-q current point is permissible,
the d component of this permissible d-q current point has the lowest value in terms of magnitude.

2. The method as claimed in claim 1, wherein the current vector associated with the operating point is used to actuate the permanent magnet synchronous motor.

3. The method as claimed in claim 1, wherein the following applies to the phase current limit:
$$0 \leq \sqrt{{I}_{q}^{2} + {I}_{d}^{2}} \leq {I}_{ph , max} .$$

4. The method as claimed in any claim 1, wherein the following applies to the voltage limit:
$$0 \leq \sqrt{{U}_{q}^{2} + {U}_{d}^{2}} \leq {U}_{ctrl} .$$

5. The method as claimed in claim 1, wherein the following applies to the power limit:
$${P}_{DC , min} \leq {P}_{DC} \leq {P}_{DC , max} .$$

6. The method as claimed in claim 1, wherein the d-q current points are ascertained mathematically.

7. The method as claimed in claim 1, wherein the possible value ranges for the d-q current points are ascertained empirically and/or are stored in a table and provided for the application of the method.

8. The method as claimed in claim 1, wherein the polynomial is a polynomial of the 1st degree.

9. The method as claimed in claim 1, wherein the polynomial is a polynomial of the n-th degree with n being 2, 3 or 4.

10. The method as claimed in claim 1, wherein the permanent magnet synchronous motor 11 is designed for operating a pump unit.

11. A control device for actuating a permanent magnet synchronous motor of a motor vehicle with instructions for:
ascertaining a first d-q current point in the d-q coordinate system, in which the phase current limit and the voltage limit are observed, and wherein the following additionally applies to the first d-q current point:
the q component of the d-q current point in the d-q coordinate system is zero, and
the d component of the d-q current point in the d-q coordinate system is selected to be as small as possible in terms of magnitude,
ascertaining a second d-q current point in the d-q coordinate system, in which the phase current limit and the voltage limit are observed, and wherein a maximum torque can be set,
ascertaining a polynomial that connects these d-q current points to one another,
ascertaining a d-q current point from the intersection of this polynomial with the curve of the power limit G_{L},
ascertaining a d-q current point from the intersection of this polynomial with the curve of the required torque G_{M}, and
selecting an operating point from the d-q current points to which the following applies:
the d-q current point is permissible,
the d component of this permissible d-q current point has the lowest value in terms of magnitude.

12. The control device as claimed in claim 11, wherein the permanent magnet synchronous motor is for a brake system of the motor vehicle.
